(19) United States
(12) Patent Application Publication
(10) Pub. No.: US 2009/0299544 A1
(43) Pub. Date: Dec. 3, 2009

(54) System and method for fan tray control and monitoring system

(75) Inventors: Yukihiro Tanada, Tempe, AZ (US); Justin Turley, Mesa, AZ (US); Desi Riedel, Phoenix, AZ (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Minebea Co., Ltd., Miyota-Machi (JP)

(21) Appl. No.: 12/130,633

(22) Filed: May 30, 2008

(51) Int. Cl. G05D 23/00; B23P 11/00

(52) U.S. Cl. 700/300; 29/428

(57) ABSTRACT

System and method for fan tray control and monitor system. According to an embodiment, the present invention provides a fan control system. In the fan control system, one or more fan tray is housed inside a chassis, which provides power to the fan tray. The fan tray includes a communication interface for connecting to a controller module that is external to and separate from the chassis. Through the controller module, a user is able to view information associated with the fan tray. In addition, the user is able to adjust various fan tray parameters through the controller module.

### CROSS-REFERENCES TO RELATED APPLICATIONS

NOT APPLICABLE

### BACKGROUND OF THE INVENTION

The present patent application related generally to cooling fans. More specifically, various embodiments of the present invention provide a system and method for monitoring and controlling fan trays. For example, an embodiment of the present invention is directed to an interface for controlling fan tray that is mounted on a chassis by an entity that is external to the chassis. Among other benefits, the fan tray interface techniques according to the present invention provide more flexibility and control compared to conventional systems.

In electronic systems, such as computer systems, cooling fans play an important role in maintaining their operational capabilities. The inability to remove excessive heat from electronic systems may lead to permanent damage of the system. Because of the complexity of existing electronic systems, cooling fans having added functionalities other than just providing cooling air, such as the ability to control the speed of a fan, the ability to monitor a tachometer pulse on a fan to determine instantaneous fan speed, and the ability to detect if a fan has failed or is slower than its preset speed, are required. Although these functionalities exist in some cooling fans today, there is no standard design or protocol that is available to control cooling fans produced by different manufacturers. Moreover, in order to implement these cooling fans within a system, specialized printed circuit assemblies (PCAs), also called controller cards, are required to be designed so as to provide signals that a fan can understand and also to receive and provide signals to the system in a form that is interpretable by the electronics of the system.

If one desires additional functionality, such as the ability for the fans to compensate for other failed fans by increasing in speed, the ability for fans to notify external hardware that there is a problem, or the ability for fans to increase speed in response to increased system temperatures, a specialized PCA or controller card is also required. The PCA or controller card is designed and built to be capable of detecting a fan failure, notifying the system that a fan has failed, and adjusting the speeds of the other fans in the system. The design and manufacture of PCAs and controller cards involve a great deal of engineering time and resources, which ultimately add to the cost of the overall system utilizing the cooling fans.

Over the past, various types of conventional systems have been developed to provide better control, reliability, and functionality to fan trays. For example, a method for providing fan tray control is described in U.S. Pat. No. 7,117,054, titled “System and Method of Designing Cooling Fans”, which is incorporated by reference herein.

FIG. 1 is a simplified illustrating a conventional cooling fan solution. The cooling fan 100 includes a fan module 110, which has a fan 112 (including fan blades) and a motor 114 rotatably coupled to the fan 112 to drive the fan 112. A microcontroller 120 is in direct communication with the fan module 110, and specifically, the motor 114. For example, the microcontroller 120 is preferably fixed internally within the cooling fan 100, and the cooling fan 100, along with other components, are located within a chassis.

A bus interface, such as the Inter-IC (I2C) bus interface 130 is in communication with the microcontroller 120. The bus interface 130 facilitates transfer of data to and from the microcontroller 120. The bus interface 130 may be interconnected by bus lines 132, such as I2C bus lines, to a system 140. For example, the system 140 is a part of a chassis. The I2C bus lines 132 have two lines: a data (SDA) line and a clock (SCL) line. Inter-IC (I2C) may be accessed serially so that each individual device utilizing the I2C protocol has a specific identification (ID), but may all be connected to the same communication lines or buses. Inter-IC (I2C) is a useful protocol because it is familiar to thermal design engineers who utilize cooling fans in their system designs, and a fair number of digital logic devices utilize the I2C protocol. For example, users and/or engineers are able to access the fan tray via the chassis in which the fan tray resides.

FIG. 2 illustrates a conventional electronic system implementing a plurality of cooling fans. A plurality of cooling fans 242, 244, 246, 248 are provided within the electronic system 200. Each of the plurality of cooling fans 242, 244, 246, 248 are electrically connected to a connector module 230, which is a line splitter for a power source 210 and a user system/device 140. According to an embodiment of the present invention, the electronic system 200 utilizes the I2C protocol, and the user system/device 140 has communication lines according to the I2C protocol, a data line 222 and a clock line 224 connected to the connector module 230. The connector module 230 in turn splits the data line 222 and the clock line 224 to each one of the plurality of cooling fans 242, 244, 246, 248. Similarly, the power source lines, power line 212 and power return line 214, from the power source 210 are connected to the connector module 230, which in turn splits the power line 212 and the power return line 214 to each one of the plurality of cooling fans 242, 244, 246, 248.

FIGS. 3A and 3B are schematic circuit diagrams for a conventional cooling fan. For example, the microcontroller 120 has program code having instructions to detect the speed of the cooling fan 100 in real time and maintain that speed, regardless of changes in the input voltage. As shown, lines 322 and 324 are Inter-IC (I2C) lines: line 322 being the data line and line 324 being the clock line for communication utilizing the I2C protocol. Typically, in cooling fan applications, the input voltage may be 12 volts, 24 volts, or 48 volts. Diodes D1 and D2 332 provide for reverse polarity protection within the system. The Zener diode D5 334 provides a drop in power and regulates the voltage to, for example, 12 volts. A 5V regulator 342 is included to provide regulated 5 volts to the microcontroller 120 and the speed sensor 116 (e.g., the Hall sensor). The Hall sensor 116 provides a digital signal to the microcontroller 120 based on the positions of the stator 380 of the fan motor 114 utilizing the Hall effect, which occurs when the charge carriers moving through a material experience a deflection because of an applied magnetic field. This deflection results in a measurable potential difference across the side of the material which is transverse to the magnetic field and the current direction. According to one embodiment, the Hall sensor 116 provides a 50% duty cycle signal. That is, two pulses for each revolution/cycle of the fan. Based on the signals provided by the Hall sensor 116, the microcontroller 120 is capable of determining the speed of the cooling fan 100 and making any adjustments necessary to maintain a constant fan speed.

Conventional systems such as the one described above are useful for many applications, as they include a variety of features for the proper functioning of the fan tray. However, for many applications, these conventional systems are inadequate. Improved systems and methods are desired.

### BRIEF SUMMARY OF THE INVENTION

The present patent application related generally to cooling fans. More specifically, various embodiments of the present invention provide a system and method for monitoring and controlling fan trays. For example, an embodiment of the present invention is directed to an interface for controlling fan tray that is mounted on a chassis by an entity that is external to the chassis. Among other benefits, the fan tray interface techniques according to the present invention provide more flexibility and control compared to conventional systems.

According to an embodiment, the present invention provides a fan control system. In the fan control system, one or more fan tray is housed inside a chassis, which provides power to the fan tray. The fan tray includes a communication interface for connecting to a controller module that is external to and separate from the chassis. Through the controller module, a user is able to view information associated with the fan tray. In addition, the user is able to adjust various fan tray parameters through the controller module.

According to another embodiment, the present invention provides a system for operating a fan tray. The system includes a chassis, the chassis being adapted to house a plurality of hardware modules. The system also includes a fan tray, the fan tray being positioned within the chassis, the fan tray being adapted to house one or more fans, the fan tray including a first communication interface and a second communication interface, the first communication interface being coupled to the chassis. The system additionally includes a controller module, the controller module being separate from the chassis, the controller module being adapted to communicate with the fan tray through the second communication interface, the controller module including a user interface for displaying information associated with the fan tray, the information including at least fan tray speed information.

According to yet another embodiment, the present invention provides a method for operating a fan tray. The method includes providing a fan tray, the fan tray being located within a chassis, the fan tray including a first communication interface and a second communication interface, the first communication interface being coupled to the chassis. The method also includes providing a controller module, the controller module being separate from the chassis, the controller module including program instructions for connecting to the fan tray. The method further includes forming a communication link between the controller and the fan tray through the second communication interface. Additionally, the method includes receiving information from the fan tray by the controller module. The method further includes displaying the information by the controller module.

It is to be appreciated that various embodiments of the present invention provide numerous advantages over conventional systems. Among other things, embodiments of the present provide a flexible and cost effective solution for accessing and controlling fans. For example, by connecting a fan to an external controller, more fan-related information can be obtained compared to conventional systems. In addition, embodiments of the present invention provide a user interface that displays fan-related information in real-time and allows users to adjust and/or control various aspects of the fan operation. In addition, embodiments of the present invention are less costly than conventional systems to implement, as conventional rotor sensors and driving circuitry may be modified to perform techniques described according to the present invention, whereas conventional systems typically require additional hardware module to analyze rotor movement. There are other benefits as well.

Various additional objects, features and advantages of the present invention can be more fully appreciated with reference to the detailed description and accompanying drawings that follow.

### BRIEF DESCRIPTION OF THE DRAWINGS

FIG. 1 is a simplified illustrating a conventional cooling fan solution.

FIG. 2 illustrates a conventional electronic system implementing a plurality of cooling fans.

FIGS. 3A and 3B are schematic circuit diagrams for a conventional cooling fan.

FIG. 4 is a simplified diagram illustrating a cooling fan control system.

FIG. 5 is a simplified diagram illustrating a fan system according to an embodiment of the present invention.

FIG. 6 is a simplified diagram illustrating a user interface according to an embodiment of the present invention.

FIG. 7 is a simplified flow diagram illustrating operation of an exemplary fan control system according an embodiment of the present invention.

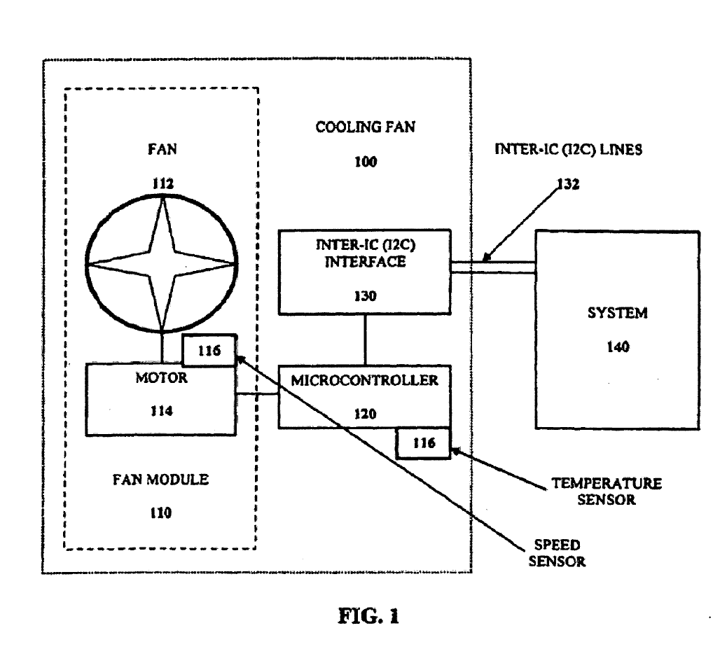

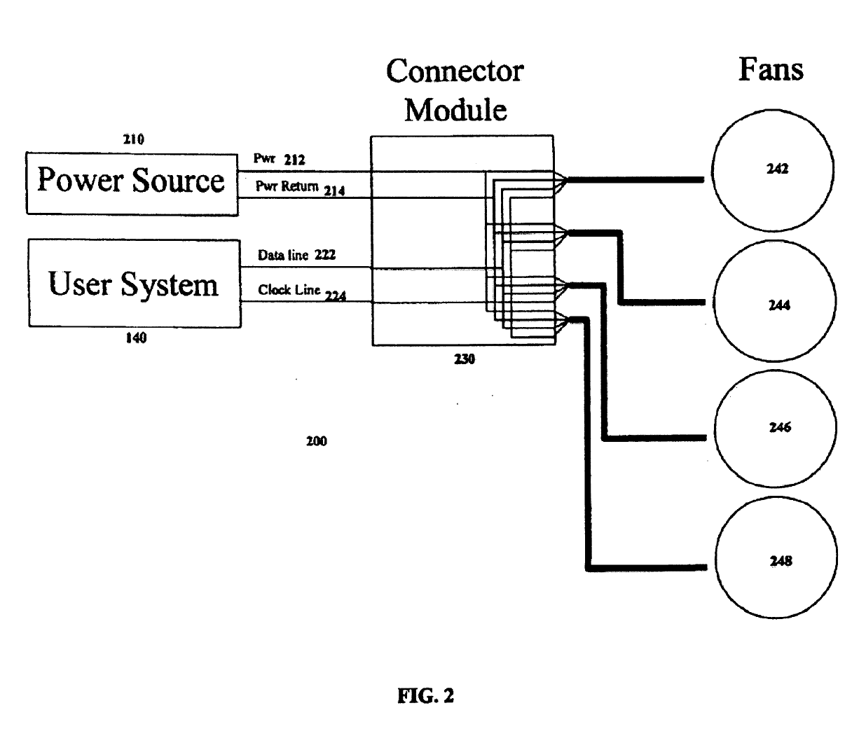

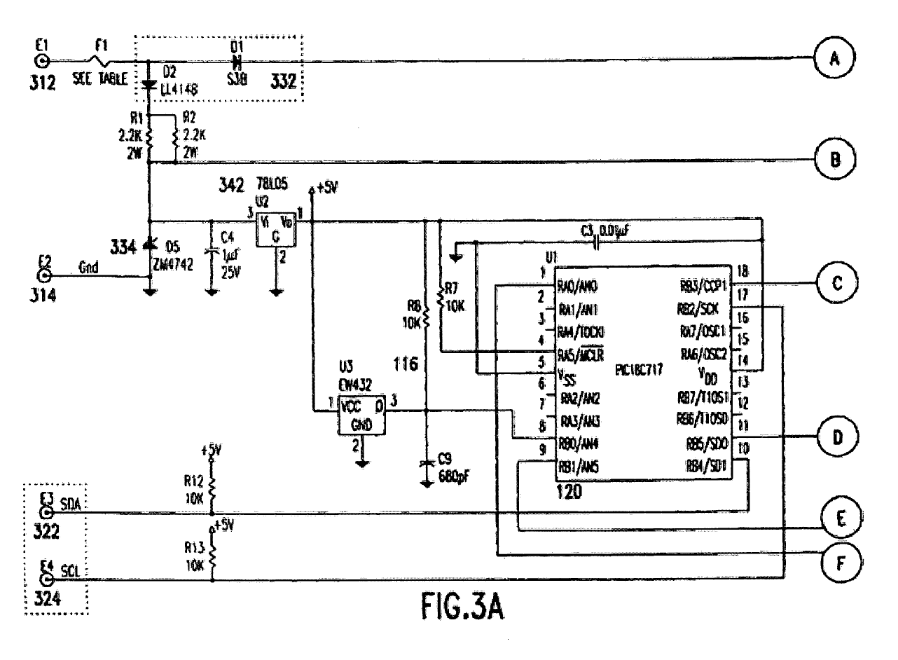

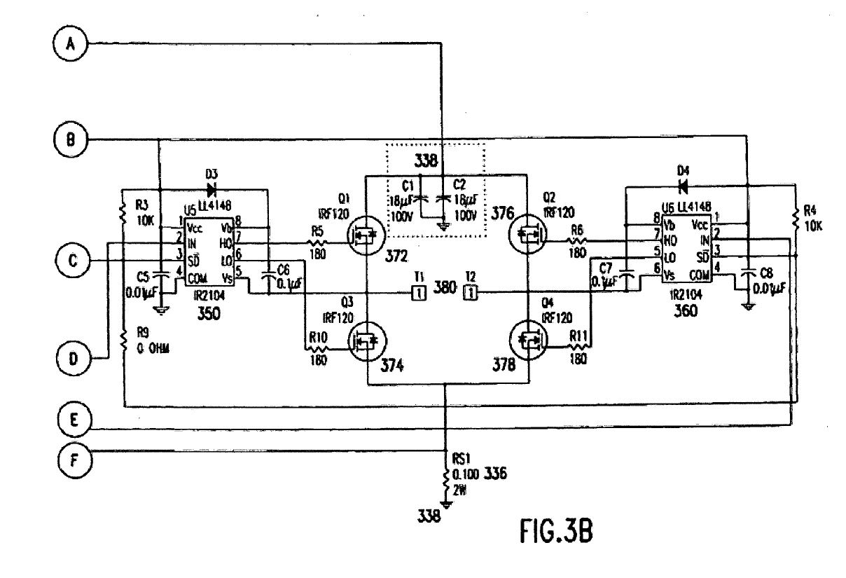

### DETAILED DESCRIPTION OF THE INVENTION

The present patent application related generally to cooling fans. More specifically, various embodiments of the present invention provide a system and method for monitoring and controlling fan trays. For example, an embodiment of the present invention is directed to an interface for controlling fan tray that is mounted on a chassis by an entity that is external to the chassis. Among other benefits, the fan tray interface techniques according to the present invention provide more flexibility and control compared to conventional systems.

Besides the ability for a fan customer and/or thermal design engineer to control the fan speed, monitor a tachometer pulse on the fan to determine instantaneous fan speed, and detect if the fan has failed or is slower than a preset speed, additional functionality, such as the ability to electronically read the part number of a cooling fan 100, the ability to electronically determine the fan manufacturer, and the ability to electronically read the manufacturing date, is particularly desirable. Because of the concern that various fan manufacturers may have different methods of controlling fan speed, or providing alarm or tachometer signals, being able to easily obtain cooling fan 100 information such as the part number, the fan manufacturer, and the manufacturing date quickly aids in the design and repair of a cooling solution.

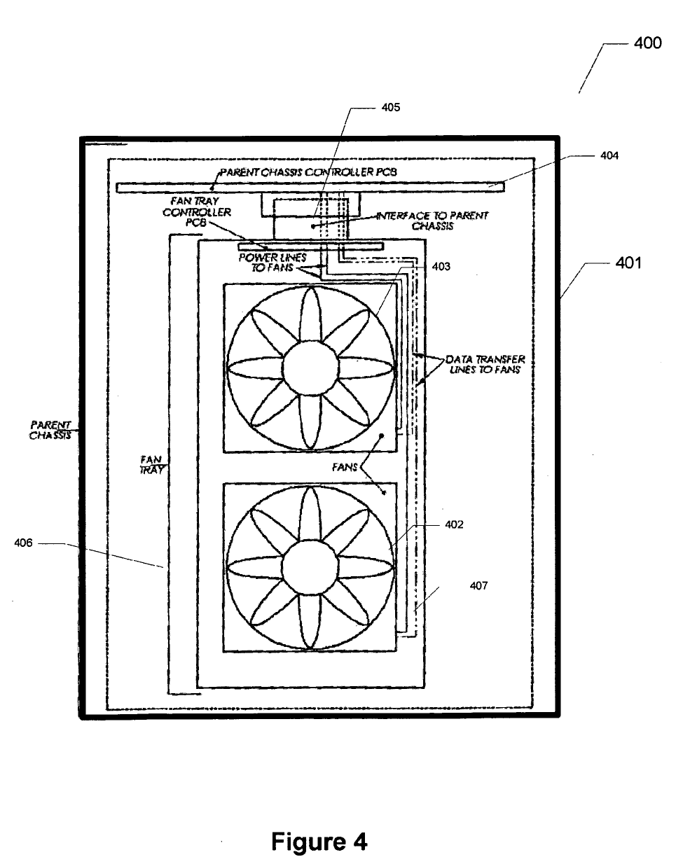

In various conventional systems, fan trays are hardly accessible to users and/or engineers. Typically, fan trays are only connected to the chassis. FIG. 4 is a simplified diagram illustrating a cooling fan control system. As shown in FIG. 4, the cooling fan control system 400 includes a parent chassis 401. The parent chassis 401 houses, among other things, the fan tray 407, and interface 405, and a controller 404. Various control functions for the cooling fan are provided by the controller 404, which is a part of the chassis. This type of configuration usually does not provide data interface for connectivity outside the chassis. In certain configurations, fan trays are accessible to users, but only through the chasses. As a result, to access fan trays means that a users and/or engineer must access the chassis, which must be properly set up for such accessibility. Since there are many types of fan trays, as there are also many types and makes of chassis, it is often impossible to have chassis that is able to access different types of fan trays. Chassis often serves no more function than providing power to fan trays. In addition, even if users are able to access fan trays through a chassis, the process and effort involve are usually complicated.

Therefore, it is to be appreciated that according to various embodiments, the present invention provides fan trays that include communication interface for connectivity outside the chassis. In a specific embodiment, a computer is set up with specific program codes to access fan trays via one or more data cable (e.g., USB cable, parallel cable, etc.) and/or wireless connection. For example, the program codes can be used to access one or more fan trays, obtain fan tray information, and/or send control signals.

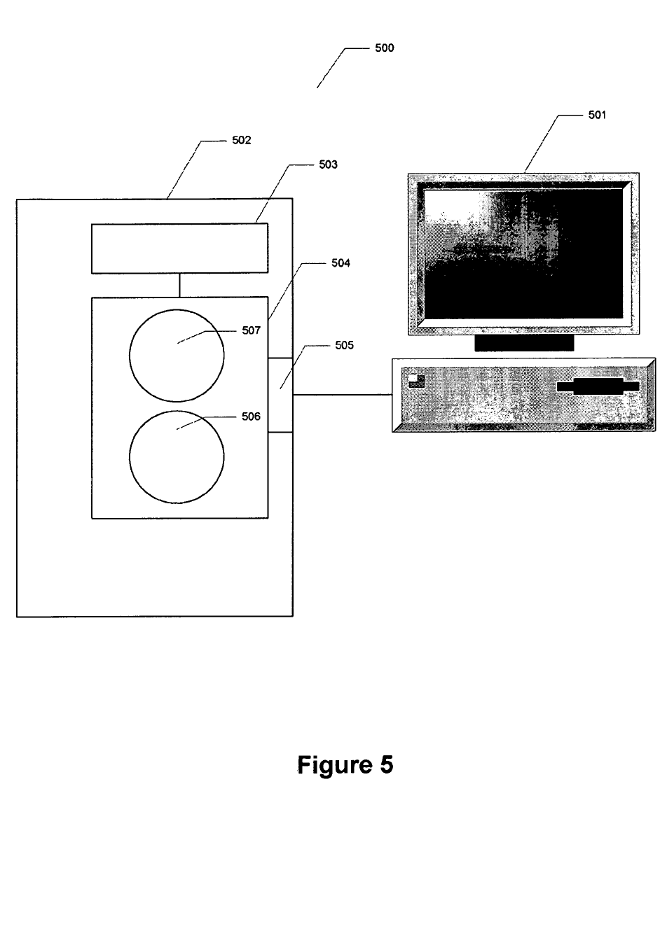

FIG. 5 is a simplified diagram illustrating a fan system according to an embodiment of the present invention. This diagram is merely an example, which should not unduly limit the scope of the claims. One of ordinary skill in the art would recognize many variations, alternatives, and modifications.

As shown in FIG. 5, the fan system 500 includes the following components:
1. a controller 501;
2. a chassis 502;
3. a chassis controller 503;
4. a fan tray 504; and
5. an interface 505.

Depending on the specific application, there might be other components. As shown, the fan tray 504 is positioned within the chassis 502. The chassis 502 also includes other components that are not shown in FIG. 5. For example, the chassis 502 is a part of a computer server, for which the chassis 502 encloses components such as disk storage, processor, power converter, etc. In addition to the fan tray 504, the chassis 502 may also include additional fan trays. The fan tray 504 is securely mounted inside the chassis and connected to the power from the chassis. Inside the fan tray 504, there might one or more fans. As merely an example, the fan tray 504 includes fans 507 and 508.

In addition to electrical connection wherein the fan tray 504 obtains power, the fan tray is also connected to other components. As an example, the fan tray is connected to the chassis controller 503. The chassis controller 503 is configured to perform a variety of functions. As explained above, however, the chassis controller 503 does not always work. For example, the chassis controller 503 may not be compatible with the fan tray 504 for the controlling. In another example, the chassis controller 503 is able of perform some basic control functions, such as switching the fans on or off, but the chassis controller 503 is not adapted form more complex functions, such as displaying details information of fans, providing user interface for controlling the fan, etc.

Therefore, it is to be appreciated that the fan tray 504 includes the interface 505 that is specifically adapted for connecting to the controller 501. In a specific embodiment, the interface 505 is a COM port interface that is configured to establishing USB types of connection. But it is to be understood that other types of connections (and/or connector types) may be used. For example, serial or parallel connectors may be used for connecting the fan tray 504 to the controller 501. In certain applications, wireless interfaces may be used. For example, the interface 505 is a wireless interface that is adapted to wirelessly communicate with the controller 501 and/or other controllers within the range of wireless communication.

In a specific embodiment, the interface 505 includes an Ethernet interface, which allows the fan system to be remotely access and controlled. For example, the fan system 500 is at a remote location from a user, and the user monitors and/or controls the fan system 500 via Ethernet network interface. Depending on the application, various protocols, such as HTTP protocol, may used for Ethernet interface communication. Other type of wired network interfaces, such as powerline communication interface, can be used as well.

As an example, the interface 505 includes a special host control device (HCD) for facilitating the communication between the fan tray 504 and the controller 501. In a specific embodiment, the interface 505 is compatible with the USB standard. The interface 505 may be adapted to connect to Type A and/or Type B USB connector.

As can be seen from FIG. 5, the interface 505 directly connects the fan tray 504 with the controller 501. In contrast to the conventional systems, the fan tray 504 does not have to communicate to external controller such as the controller 501 through the chassis 502. In a specific embodiment, commonly available interface/connector such as USB connector is used, thereby allowing convenient and low-cost connectivity.

The controller 501, depending on the embodiment, can be implemented using various systems. As shown in FIG. 5, the controller 501 is a general personal computer that includes an interface that is compatible with the connector that is used for connecting to the interface 505 of the fan tray 504. It is to be appreciated that the interface 505 of the fan tray allows a variety of systems to connect to the fan tray. For example, the controller 501 may be implemented using a laptop computer (or even a personal digital assistant) that includes program instructions for, among other things, communicating with the fan tray. In various embodiments, proprietary software is installed on the controller for the purpose of communicating with and/or controlling the fan tray.

The controller 501 may be connected to the fan tray 504 in many ways. For example, the controller includes a USB connector, which is used for connecting to the fan tray. But it is understood that other types of connectors may be used. As an alternative to the USB connection, wireless communication link may be used for communicating between the controller and fan tray.

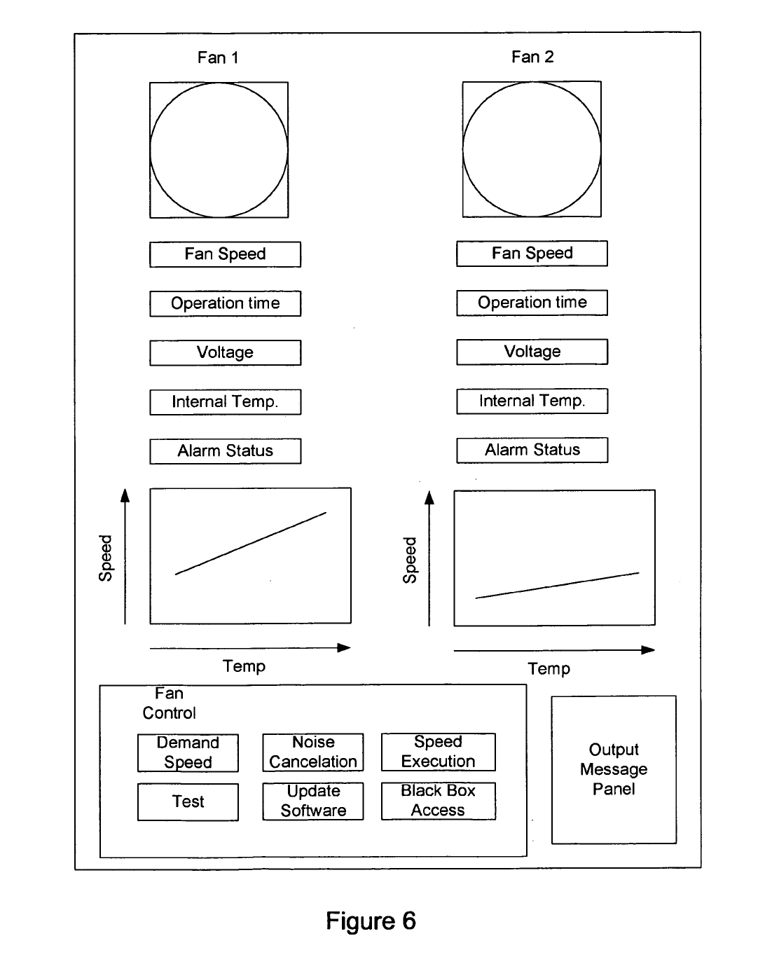

The controller 501 is configured to provide a convenient user interface, both for displaying various information associated with fan trays and for receiving user inputs for controlling the fan tray. FIG. 6 is a simplified diagram illustrating a user interface according to an embodiment of the present invention. This diagram is merely an example, which should not unduly limit the scope of the claims. One of ordinary skill in the art would recognize many variations, alternatives, and modifications.

As shown in FIG. 6, the user interface is configured to display information associated with two fans: Fan 1 and Fan 2. For example, Fan 1 and Fan 2 are the fans 506 and 507 shown in FIG. 5. Depending on the specific configuration of the fan tray, there could fewer and more fans, any or all of which can be displayed on the user interface.

For each of the fan, information is displayed in organized information fields. As shown, the following information is displayed in separate panels for each fan:
1. fan speed;
2. operation time;
3. voltage;
4. internal temperature; and
5. alarm status.

The fan speed panel displays the rotational speed of the fan. For example, the fan speed is measured in the unit of RPM. The operation time panel indicates the total amount of time that the fan has been operating. The internal fan temperature panel displays the operating temperature measured for the fan. The voltage panel displays the operating voltage of the fan. The alarm status panel provides an indication as whether there are errors with the operation of the fan. For example, an error may be caused by irregular fan speed (e.g., irregular stoppage, over speed, etc), abnormal voltage, etc.

In addition to the numerical values, the user interface as shown also provides a graph to illustrate relationship among various numerical values. For example, a graph is used to the relationship between temperature and fan speed. The positive slope as shown in FIG. 5 appears to demonstrate a direct relationship between fan temperature and fan speed. That is, that faster the fan rotates, the higher temperature for the fan. The temperature may also be related to the temperature inside the chassis in which the fan is operating. For example, the faster operating speed of the fan allows heat to dissipate faster from the chassis. Depending on the specific needs, other graphs may be used, such as voltage v. temperature graph, etc.

In addition to displaying information, the user interface is also adapted to receive various user inputs. As shown, various parameters may be adjusted via user inputs. For example, these parameters include demand speed, noise cancellation, speed execution, test, software update, black box access, etc. In an embodiment, the black box access provides a mechanism for collecting the operating life of the fan and predicting the existing lifetime that fan has left. For example, the black box access allows collecting voltages, currents, and temperatures within the fan tray for the last 5 seconds of operation in order to determine the telemetry of the fan tray if a failure occurs. There may be other parameters as well.

It is to be appreciated that the user interface both provides information and receives user inputs. A user is able to look at real time information update for one or more fans, and to make adjustments using the fan control panel accordingly. For example, the based on the temperature information as received from the fan tray, the user may decide to speed up or slow down the fan. A user is also able to use various diagnostic and/or initiation routine for the fans. In certain embodiments, users may access various vendor specific functions of the fan.

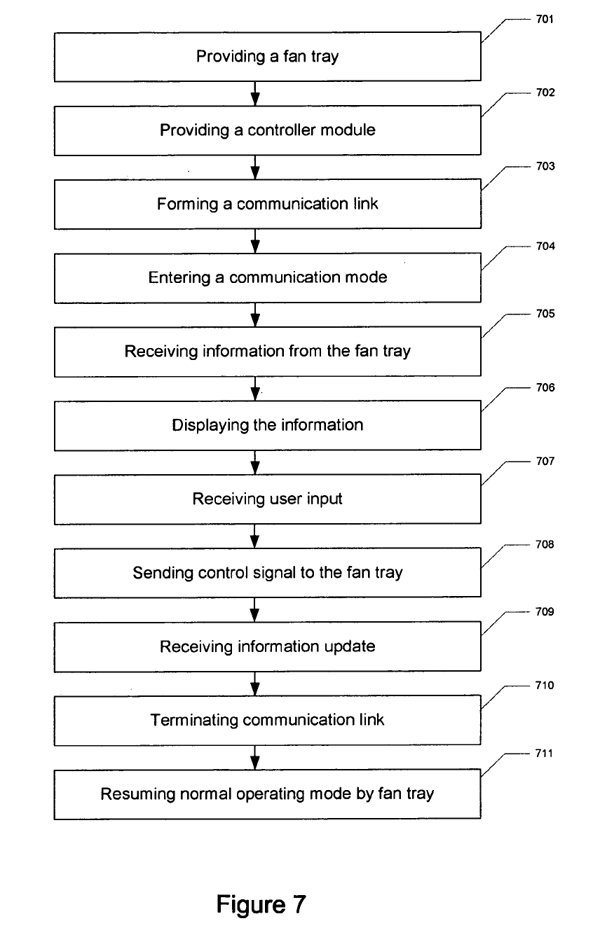

FIG. 7 is a simplified flow diagram illustrating operation of an exemplary fan control system according an embodiment of the present invention. This diagram is merely an example, which should not unduly limit the scope of the claims. One of ordinary skill in the art would recognize many variations, alternatives, and modifications. As an example, various steps may be added, removed, repeated, rearranged, replaced, modified, and/or overlapped.

As shown in FIG. 7, operation of a fan control system includes the following steps:
1. providing a fan tray 701;
2. providing a controller module 702;
3. forming a communication link 703;
4. entering a communication mode 704;
5. receiving information from the fan tray 705;
6. displaying the information 706;
7. receiving user inputs 707;
8. sending control signal to the fan tray 708;
9. receiving information update 709;
10. terminating communication link 710; and
11. resuming normal operating mode by fan tray 711.

As an example, the fan control system is the system 500 shown in FIG. 5. In step 701, a fan tray is provided. For example, the fan tray is the fan tray 504 shown in FIG. 5. In step 702, a controller module is provided. As merely an example, the controller module may be a general purpose computer that includes a communication interface for connecting to the fan tray.

At step 703, a communication link is formed. Depending on the application, various types of link may be used. In a specific embodiment, USB cable is used for connecting between the fan tray and the controller module. Other types of connections (such as wireless connection, Ethernet connection, parallel connection, etc.) may also be used.

At step 704, the fan tray enters a communication mode. For example, in the communication mode, the fan tray enters into a mode where the chassis is no longer in control of the fan tray, and operation of the fan tray can be controlled by the controller.

At step 705, information is received from the fan tray. For example, information may include fan temperature, speed, voltage, operation time, alarm status, and others. According to various embodiments, the information received is in real time, which allows a user to make adjustment to the fan accordingly.

At step 706, the information received from the fan tray is received. As an example, the information is displayed in a graphical user interface as illustrated in FIG. 6.

At step 707, user input(s) are received. According to embodiments, user inputs include demand speed, noise cancellation, black box access, self test, software upload, and others. The user input may be entered through keyboard, mouse, and/or other types of input devices.

At step 708, control signal is sent to the fan tray. The controller generates the control signal based on the user input received. The controller sends the control signal to the fan tray through the communication link.

At step 709, updated information is received. For example, the information reflects changes in operation of the fan due to the control signal sent to the fan tray. Further user inputs may be received by the controller and new control signal may be sent. For example, the update information may show a change in fan speed if earlier control signal indicates that the fan should slow down.

At step 710, the communication link is terminated. According to an embodiment, a user initiation a software routine for disconnecting the communication link between the controller and the fan tray. In a specific embodiment, a user simply physically disconnect the communication link.

At step 711, the fan tray resumes normal operation mode. For example, in the normal operation mode, the operation of the fan tray is controlled by the fan tray itself and/or an internal controller of the chassis.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A system for operating a fan tray, the system comprising:
a chassis, the chassis being adapted to house a plurality of hardware modules;
a fan tray, the fan tray being positioned within the chassis, the fan tray being adapted to house one or more fans, the fan tray including a first communication interface and a second communication interface, the first communication interface being coupled to the chassis; and
a controller module, the controller module being separate from the chassis, the controller module being adapted to communicate with the fan tray through the second communication interface, the controller module including a user interface for displaying information associated with the fan tray, the information including at least fan tray speed information.

2. The system of claim 1 wherein the second communication interface comprises an Ethernet interface.

3. The system of claim 1 wherein the second communication interface comprises a USB interface.

4. The system of claim 1 wherein the second communication interface is in compliance with an I2C protocol.

5. The system of claim 1 wherein the second communication interface comprises a wireless interface.

6. The system of claim 1 wherein the user interface includes an output message panel.

7. The system of claim 1 wherein the user interface is adapted to receive user inputs.

8. The system of claim 7 wherein the user inputs include speed control.

9. The system of claim 1 wherein the controller module is adapted to send a control signal to the fan tray in response to a user input.

10. The system of claim 1 wherein the information further includes temperature information.

11. The system of claim 1 wherein the information further includes voltage information.

12. The system of claim 1 wherein the information further includes operation time information.

13. The system of claim 1 wherein the user interface displays a graph.

14. A method for operating a fan tray, the method comprising:
providing a fan tray, the fan tray being located within a chassis, the fan tray including a first communication interface and a second communication interface, the first communication interface being coupled to the chassis;
providing a controller module, the controller module being separate from the chassis, the controller module including program instructions for connecting to the fan tray;
forming a communication link between the controller and the fan tray through the second communication interface;
receiving information from the fan tray by the controller module; and
displaying the information by the controller module.

15. The method of claim 14 wherein the forming a communication link comprises entering into a test mode by the fan tray.

16. The method of claim 15 further comprising detecting a connection with the fan tray by the controller module.

17. The method of claim 14 wherein the communication link comprises a USB communication link.

18. The method of claim 14 further comprising:
receiving a user input;
sending a control signal from controller module to the fan tray, the control signal being associated with the user input.

19. The method of claim 14 further comprising:
receiving a user input;
sending a request to the fan tray based on the user input;
receiving data associated with the request.

20. The method of claim 14 further comprising displaying a graph based on the information.

21. The method of claim 14 wherein the information includes speed, temperature, voltage, alarm status, and/or operating time information.

22. The method of claim 14 further comprising updating a fan tray software in response to a user input.

23. The method of claim 14 wherein the fan tray includes two or more fans.

24. The method of claim 14 wherein the information is displayed in real time.

25. The method of claim 14 further comprising performing function override of the fan tray based on a user input received by the controller.

26. The method of claim 14 further comprising:
terminating the communication link between the fan tray and the controller;
resuming fan tray operation.

27. The method of claim 14 further comprising storing the information.
